(19) United States
(12) Patent Application Publication
(10) Pub. No.: US 2026/0362552 A1
(43) Pub. Date: Nov. 12, 2026

(54) REFORMING APPARATUSES AND METHODS

(71) Applicant: Infinium Technology, LLC, Sacramento, CA (US)

(72) Inventors: Ramer RODRIGUEZ, Sacramento, CA (US); James BUCHER, Boston, MA (US); Anand CHIRAVURI, Dallas, TX (US); Glenn McGINNIS, Sun Lakes, AZ (US); Orion HANBURY, Sacramento, CA (US); Roger Allen HARRIS, Dallas, TX (US); Steven John STEWART, Overland Park, KS (US); Brandon GARCZYNSKI, Concord, CA (US)

(73) Assignee: Infinium Technology, LLC, Sacramento, CA (US)

(21) Appl. No.: 19/200,161

(22) Filed: May 6, 2025

(51) Int. Cl. H05B 1/02

(52) U.S. Cl. CPC H05B 1/0247

(57) ABSTRACT

Systems and methods of a reforming apparatus are provided. The reforming apparatus can include a catalyst tube. The catalyst tube can extend between a first and second platform. The reforming apparatus can include a first and second heating element. The first and second heating elements can be disposed around a circumference of the catalyst tube and at a first and second portion of the catalyst tube. The reforming apparatus can include a busbar. The busbar can couple with the heating elements. The busbar can transmit power from a power source to the heating elements. The reforming apparatus can include a connector element to couple with the busbar and with the heating elements. The controller can be communicatively coupled with the heating elements. The controller can operate the first heating element at a first temperature and the second heating element at a second temperature.

### BACKGROUND

Methane can undergo a reaction with steam to produce hydrogen and carbon monoxide, among other reactions.

### SUMMARY

At least one aspect is directed to a reforming apparatus. The reforming apparatus can include a catalyst tube. The catalyst tube can extend between a first platform and a second platform. The reforming apparatus can also include a first heating element and a second heating element. The first heating element can be disposed around a circumference of the catalyst tube and at a first portion of the catalyst tube. The second heating element can be disposed around a circumference of the catalyst tube and at a second portion of the catalyst tube. The reforming apparatus can include a busbar. The busbar can couple with the first heating element. The busbar can couple with the second heating element. The busbar can transmit power from a power source to the first heating element. The busbar can transmit power from the power source to the second heating element. The reforming apparatus can include a connector element. The connector element can couple with the busbar. The connector element can couple with the first heating element. The connector element can couple with the second heating element. The reforming apparatus can include a controller. The controller can be communicatively coupled with the first heating element. The controller can be communicatively coupled with the second heating element. The controller can operate the first heating element at a first temperature. The controller can operate the second heating element at a second temperature.

At least one aspect is directed to a method of producing a reforming apparatus. The method can include receiving a catalyst tube. A first platform and the second platform can receive the catalyst tube. The method can include coupling a heating element with the catalyst tube. The heating element can be disposed around a circumference of the catalyst tube and at a portion of the catalyst tube. The method can include coupling a busbar with the heating element. The busbar can transmit power from a power source to the heating element. The method can include coupling a connector element with the busbar. The method can include coupling the connector element with the heating element. The method can include providing a fan to direct air through one or more openings in the second platform to cool the busbar and the connector element.

At least one aspect is directed to a method. The method can include providing a reforming apparatus. The reforming apparatus can include a catalyst tube. The catalyst tube can extend between a first platform and a second platform. The reforming apparatus can also include a first heating element and a second heating element. The first heating element can be disposed around a circumference of the catalyst tube at a first portion of the catalyst tube. The second heating element can be disposed around a circumference of the catalyst tube at a second portion of the catalyst tube. The reforming apparatus can include a busbar. The busbar can couple with the first heating element. The busbar can couple with the second heating element. The busbar can transmit power from a power source to the first heating element. The busbar can transmit power from the power source to the second heating element. The reforming apparatus can include a connector element. The connector element can couple with the busbar. The connector element can couple with the first heating element. The connector element can couple with the second heating element. The reforming apparatus can include a controller. The controller can be communicatively coupled with the first heating element. The controller can be communicatively coupled with the second heating element. The controller can operate the first heating element at a first temperature. The controller can operate the second heating element at a second temperature.

At least one aspect is directed to a method for retrofitting a reforming apparatus. The method can include removing a heating source from a reforming apparatus. The heating source can be a burner. The burner can be coupled with a combustion chamber. The method can include removing the combustion chamber from the reforming apparatus. The method can include installing a heating element around a portion of a circumference of a catalyst tube. The method can include installing a connector element. The connector element can be structured to support the heating element. The connector element can be structured to support a busbar. The method can include coupling the busbar with the connector element. The method can include coupling the busbar with a power source. The method can include coupling the busbar with the heating element, such that the busbar can transmit power from the power source to the heating element.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 depicts an example reforming apparatus.

FIG. 2 depicts an example reforming apparatus.

FIG. 3 depicts an example reforming apparatus.

FIG. 4A depicts an example reforming apparatus.

FIG. 4B depicts an example reforming apparatus.

FIG. 5 depicts an example reforming apparatus.

FIG. 6 depicts an example reforming apparatus.

FIG. 7 depicts an example controller.

FIG. 8 depicts an example heating element.

FIG. 9 depicts an example reforming apparatus.

FIG. 10 depicts an example reforming apparatus.

FIG. 11 depicts an example reforming apparatus.

FIG. 12 depicts an example reforming apparatus.

FIG. 13 depicts an example maintenance platform.

FIG. 14 depicts an example reforming apparatus.

FIG. 15 depicts an example method of producing a reforming apparatus.

FIG. 16 depicts an example method of providing a reforming apparatus.

### DETAILED DESCRIPTION

Following below are more detailed descriptions of various concepts related to, and implementations of a reforming apparatus. The various concepts introduced above and discussed in greater detail below can be implemented in any of numerous ways.

The reforming apparatus described herein can, for example, convert methane mixed with steam to hydrogen and carbon monoxide. A reforming apparatus can use heat to cause a reaction between the steam and methane in order to convert the steam and methane into hydrogen and carbon monoxide. Heating sources that rely on fossil fuels or other carbon based fuels can generate excessive carbon dioxide emissions or other greenhouse gas emissions. It can be challenging to control the heating sources to evenly heat the steam and methane, or to vary the heating of the steam and methane along a length of the reforming apparatus.

These and other technical problems can be solved by a reforming apparatus and methods described herein. The reforming apparatus can include a catalyst tube. The catalyst tube can extend between a first platform and a second platform. The reforming apparatus can include a heating element that can be disposed around the circumference of the catalyst and at a portion of (e.g., along a length of) the catalyst tube. The heating element can include a first heating element and a second heating element. The heating elements can be electrically powered. Beneficially, powering the heating elements by electricity can be less carbon intensive than heating sources that utilize fossil fuels or other carbon based fuels to generate heat. A busbar can connect the heating elements with a power source. For example, the busbar can connect the heating elements with an electric power source, such as a power grid, microgrid, a battery, battery pack, energy storage system, or the like. Electricity can be provided by renewable sources such as solar power, wind power, hydro-electric power, for example. The reforming apparatus can include a connector element coupled with the busbar and with the heating elements. The connector element can be structured to provide support the busbar and the heating elements.

The reforming apparatus can include a controller communicatively coupled with the first heating element and with the second heating element. The controller can operate the first heating element at a first temperature and the second heating element at a second temperature. The first temperature and second temperature can differ. For example, the first temperature can be higher than the second temperature. This control system results in more precise and regular heating that drives the reaction between the steam and methane more effectively. For example, the first heater operating at the higher first temperature can be positioned near an inlet of the steam and methane mixture. Delivering a higher temperature of heat to the steam and methane mixture earlier in the reaction can lead to a more effective reaction that converts the steam and methane mixture to hydrogen and carbon monoxide more quickly.

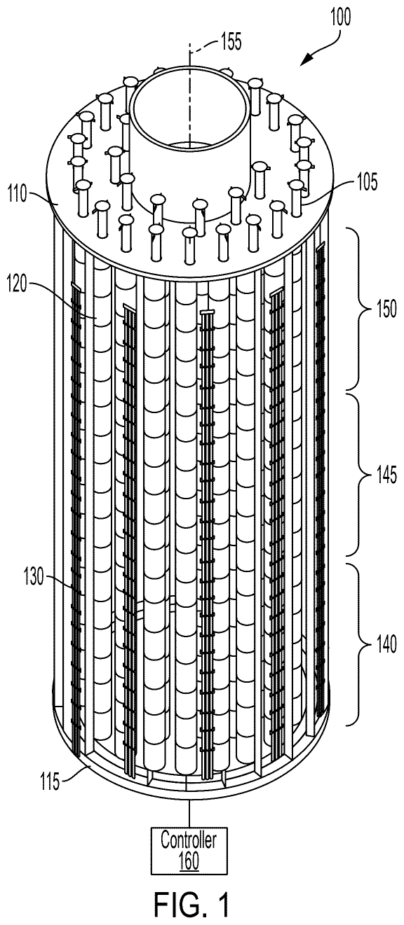

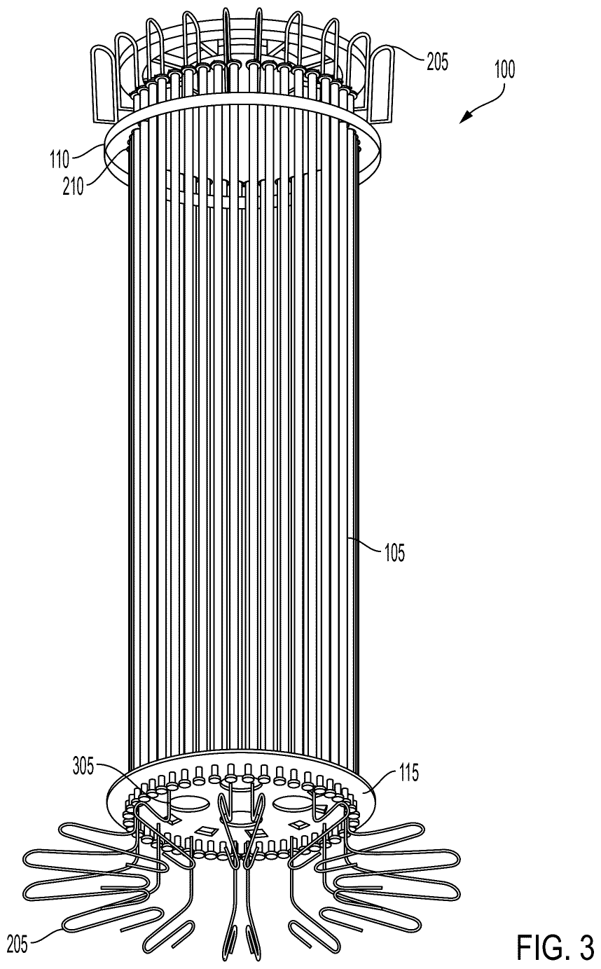

FIGS. 1-3, among others, depicts an example reforming apparatus 100. The reforming apparatus 100 can include a reactor unit used to produce hydrogen or a gas including hydrogen and carbon monoxide (e.g., syngas). For example, the reforming apparatus 100 can heat a mixture of natural gas (e.g., methane) and steam within a reactor vessel at elevated temperatures (e.g., 700 °C to 1100 °C) and pressures (e.g., 20 to 30 bar) to generate a gas including carbon monoxide and hydrogen (e.g., syngas). The reforming apparatus 100 can heat the mixture of natural gas and steam to generate gas including carbon monoxide and hydrogen, while some of the mixture of natural gas and steam remains unconverted, e.g., at less than a 100% conversion rate.

The reforming apparatus 100 can include at least one catalyst tube 105. For example, the catalyst tube 105 can contain one or more catalysts within its interior. For example, the interior of the catalyst tube 105 can include catalysts, such as nickel, nickel alumina, noble metals, bimetallic, or other known catalysts in the art. The catalyst tube 105 can receive gas from a gas source. For example, the catalyst tube 105 can receive the mixture of steam and methane. The catalyst tube 105 can receive natural gas, multi-carbon compounds (e.g., C₂+), naphtha, ethanol, methanol, carbon dioxide and hydrogen, or any other gases or liquids containing at least one of hydrogen or carbon. The catalyst tube 105 can facilitate the conversion of the gases or liquids containing at least one of hydrogen or carbon into hydrogen, carbon monoxide, and carbon dioxide. Accordingly, the catalyst tube 105, among other components of the apparatus 100, can reform the gas the catalyst tube 105 receives from the gas source into different gases (e.g., hydrogen, carbon monoxide, carbon dioxide, syngas, etc.). In this way, the reforming apparatus 100 can be feedstock flexible. Feedstock flexible refers to the capability of the reforming apparatus 100 to convert multiple type of input materials to produce hydrogen or syngas.

The catalyst tube 105 can be made of alloys that are resistant to heat (e.g., rated to withstand temperatures of 800 °C to 1200 °C). The catalyst tube 105 can be cylindrical, for example, or any other suitable shape, such as a rectangular prism. The catalyst tube 105 can have a uniform circumference or varying circumferences. For examples, the circumference of the catalyst tube 105 at a first point can have a greater circumference than a circumference of the catalyst tube 105 at a second point. The catalyst tube 105 can be 30-50 feet in length, for example. The catalyst tube 105 can have a 3-6 inch outer diameter. The catalyst tube 105 can have a thickness of 0.3-0.6 inches. The catalyst tube 105 can have dimensions greater than or less than these examples.

The catalyst tube 105 can extend between at least one first platform 110 and at least one second platform 115. The first platform 110 and the second platform 115 can define a first end and a second end of the reforming apparatus 100. For example, the first platform 110 can be a top platform, and the second platform 115 can be a bottom platform with the reforming apparatus 100 in an operational orientation as in FIG. 1. The second platform 115 can be a first distance from a ground surface while the first platform 110 is a second distance from the ground surface. The first distance can be less than the second distance, such that the second platform 115 is closer to the ground surface than the first platform 110. The first platform 110 and the second platform 115 can be circular, partially circular, or substantially circular in shape, however, the first platform 110 and the second platform 115 can be any suitable shape (e.g., semicircular, square, rectangular, or any other polygonal shape).

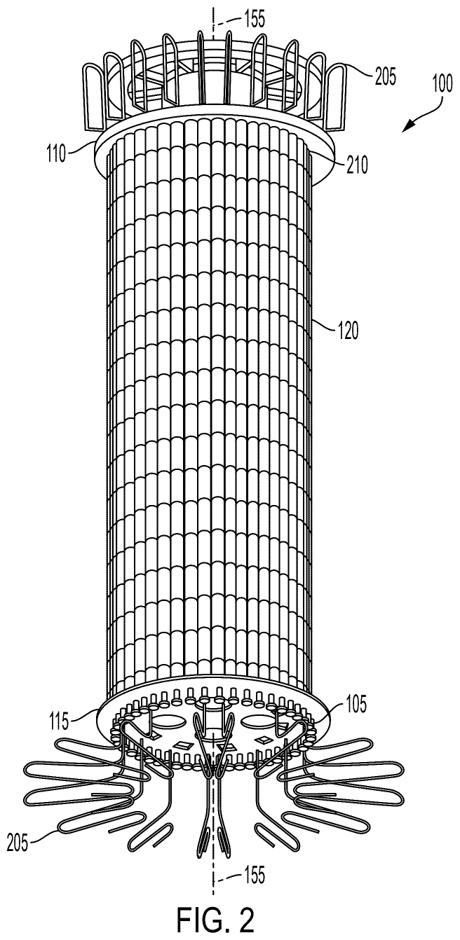

The catalyst tube 105 can couple with one or both of the first platform 110 and the second platform 115. For example, the catalyst tube 105 can be directly coupled with the first platform 110 and the second platform 115 (e.g., by welding, adhesive, etc.) or indirectly coupled with the first platform 110 and the second platform 115 via an intervening member (e.g., a collar, a receiving mechanism, etc.). As shown in FIG. 2, among others, the first platform 110 and the second platform 115 can each include at least one first opening 210. The first opening 210 within the first platform 110 can receive the catalyst tube 105. For example, a first end of the catalyst tube 105 can extend through and beyond the first opening 210 in the first platform 110. The second end of the catalyst tube 105 can extend through the first opening 210 in the second platform 115.

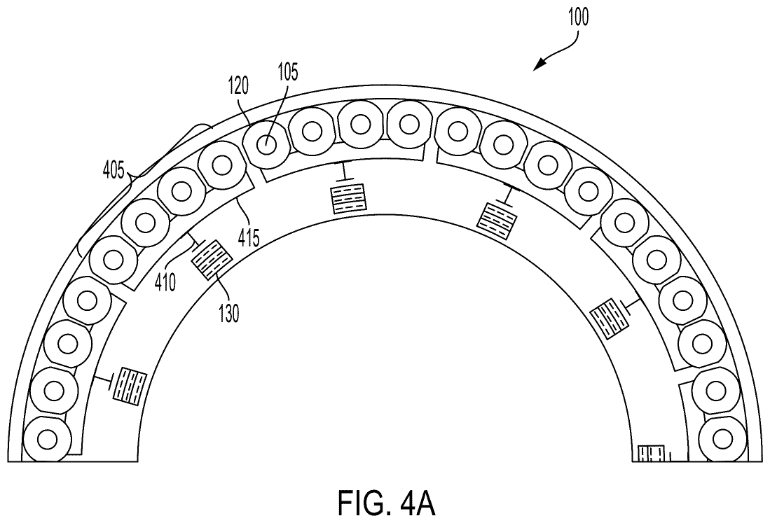

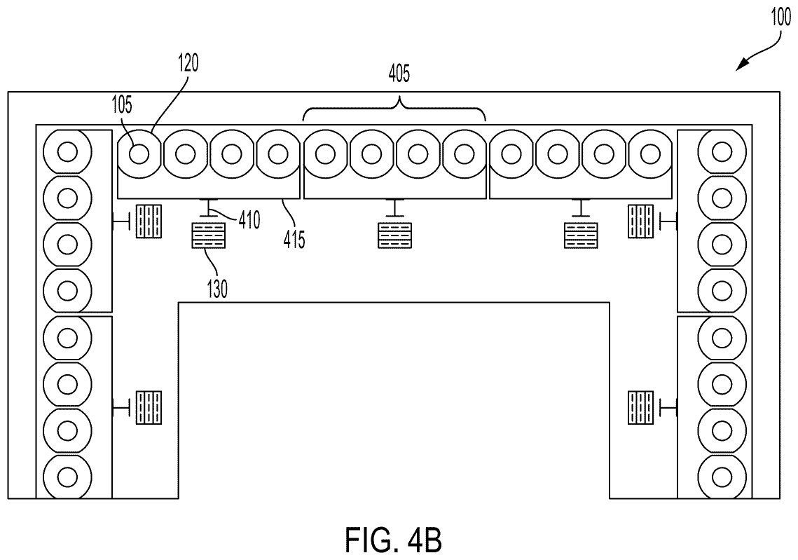

The catalyst tube 105 can be arranged alongside other catalyst tubes 105. For example, and as shown in FIG. 1, among others, a first catalyst tube 105 can be positioned a first distance from a central longitudinal axis 155 of the reforming apparatus 100, and a second catalyst tube 105 can be positioned a second distance from the central longitudinal axis 155. The central longitudinal axis 155 can be an axis running longitudinally through the center point of the reforming apparatus 100. The second distance can be greater than the first distance, such that the second catalyst tube 105 is positioned farther from the central longitudinal axis 155 of the reforming apparatus 100. For example, one or more first catalyst tubes 105 can be arranged in a first circle, each of the one or more first catalyst tubes 105 positioned the first distance from the central longitudinal axis 155. One or more second catalyst tubes 105 can be arranged in a second circle, concentric with the first circle, each of the one or more second catalyst tubes 105 positioned the second distance from the central longitudinal axis 155. For example, and as shown in FIGS. 2-4A, among others, the catalyst tubes 105 can be arranged in a single circle arranged proximate an edge of the first platform 110 and the second platform 115. As shown in FIG. 4B, the catalyst tubes 105 can be arranged in rectangular pattern or a square pattern. The catalyst tubes 105 can be arranged in any suitable pattern. For example, the catalyst tubes 105 can be arranged in pattern that forms a triangle, a square, a rectangle, box, a trapezoid, a parallelogram, quadrilateral, a pentagon, or any other polygonal shape. The catalyst tubes 105 can be arranged in one or more lines, such that the arrangement of the catalyst tubes 105 forms a striped pattern.

The reforming apparatus 100 can include at least one heating element 120. For example, heating element 120 can convert power it receives into heat. The heating element 120 can be an electric heating element that receives electrical power. For example, the heating element 120 can resist a flow of electrical current to generate thermal energy. The heating element 120 can be disposed at or around at least a portion of the catalyst tube 105, such that the heating element 120 transmits the thermal energy it generates to the catalyst tube 105. For example, the heating element 120 can be disposed around at least a portion of a circumference of the catalyst tube 105. The heating element 120 can be disposed around 50% or more, at least 75%, at least 90%, or 99% to 100% of the circumference of the catalyst tube 105.

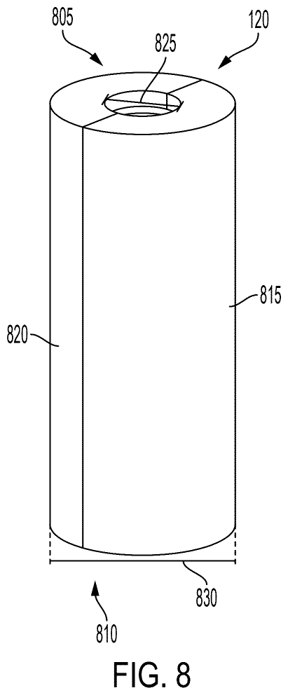

The heating element 120 can be a clamshell heater. As shown in FIG. 8, among others, the heating element 120 can include a first semi-circular segment 815 and a second semi-circular segment 820. The first semi-circular segment 815 and the second semi-circular segment 820 can be arranged opposite of one another. For example, a non-curved portion of the first semi-circular segment 815 can be arranged opposite a non-curved portion of the second semi-circular segment 820. The heating element 120 can define an inner diameter 825 and an outer diameter 830. The inner diameter 825 can be sized to receive the catalyst tube 105. For example, the inner diameter 825 of the heater element 120 can be sized such that the inner portion of the heater element 120 touches the catalyst tube 105. The inner diameter 825 can be sized such that the inner portion of the heater element 120 is spaced apart from the catalyst tube 105.

The heating element 120 can include a first heating element 120 and a second heating element 120. The first heating element 120 and the second heating element 120 can both be arranged along a length of the same catalyst tube 105. For example, a top end 805 of the first heating element 120 can abut a bottom end 810 of the second heating element 120. The top end 805 of the first heating element 120 can be spaced apart from the bottom end 810 of the second heating element 120. The top end 805 of the first heating element 120 can touch the bottom end 810 of the second heating element 120 via an intervening element. For example, the intervening element can be insulation positioned between the top end 805 first heating element 120 and the bottom end 810 second heating element 120.

The first heating element 120 can be disposed around at least a portion of a circumference of a first catalyst tube 105. The second heating element 120 can be disposed around at least a portion of a circumference of a second catalyst tube 105. The first catalyst tube 105 can be positioned next to the second catalyst tube 105. For example, the first heating element 120 and the second heating element 120 can be positioned such that the outer surface of the first heating element 120 touches the outer surface of the second heating element 120. The outer surface of the first heating element 120 can be laterally spaced apart from the outer surface of the second heating element 120. The outer surface of the first heating element 120 can touch the outer surface of the second heating element 120 through an intervening member. For example, the intervening element can be insulation positioned between the outer surface of the first heating element 120 and the outer surface of the second heating element 120.

During heating, the catalyst tubes 105 can undergo thermal expansion. The thermal expansion can cause the catalyst tubes 105 to increase in length or diameter. For example, the catalyst tubes 105 can expand longitudinally. To accommodate this expansion, the reforming apparatus 100 can include at least one coil 205 positioned near or in proximity to the catalyst tube 105. The coil 205 can be or include a curved, flexible structure. For example, the coil 205 can receive or come into contact with an end of the catalyst tube 105 when the catalyst tube 105 expands. The coil 205 can bend to accommodate the thermal expansion of the catalyst tube 105.

FIGS. 4A-6, among others, depicts an example reforming apparatus 100. The reforming apparatus 100 can include at least one busbar 130. For example, the busbar 130 can include one or more electrically conductive members. For example, the busbar 130 can be one or more copper, brass, or aluminum strips or bars coupled with one another. The busbar 130 can transmit power from a power source to a component of the reforming apparatus 100. For example, the busbar 130 can couple with the heating element 120 to transmit power from the power source to the heating element 120. For example, the heating element 120 can include an electric heating element powered by electrical current. The busbar 130 can be electrically coupled with the heating element 120 and with an electric power source (e.g., an electric grid, at least one battery, etc.) via one or more electrical cables 515. The busbar 130 can transmit electrical current from the electric power source to the heating element 120. The power source can include a fossil fuel or carbon-based fuel supply, such as a natural gas supply, gasoline supply, or other suitable fuel source.

The reforming apparatus 100 can include at least one connector element 620. For example, the connector element 620 can be or include any of: at least one beam 410, at least one lateral support 415, or at least one longitudinal support 610. The connector element 620 can be or include a structural element that can couple with the busbar 130 and support the busbar 130. The connector element 620 can be structured to support the heating element 120.

For example, the beam 410 can include an I-beam, a T-beam, a tubular beam, or a rectangular beam. The beam 410 can be made of a heat resistant metal or metal alloy. The beam 410 can extend between the first platform 110 and the second platform 115. The beam 410 can be positioned aside the catalyst tube 105. For example, the beam 410 can be closer to the central longitudinal axis 155 than the catalyst tube 105. The lateral support 415 can be a strip that extends from the beam 410. The lateral support 415 can be made of a heat-resistant metal or metal alloy. The lateral support 415 can curve or bend according to the shape of the reforming apparatus 100. For example, the lateral support 415 can curve corresponding to the curve of the first circle or the second circle of catalyst tubes 105 described above. The beam 410 can couple with the lateral support 415. For example, a first edge of the lateral support 415 can couple with the beam 410 such that the lateral support 415 extends away from the beam 410. The lateral support 415 can be fixedly coupled with the beam 410 (e.g., by welding, soldering, adhesive, etc.) or removably coupled with the beam 410 (e.g., by bolts, screws, brackets, etc.).

The longitudinal support 610 can extend parallel to the beam 410. The longitudinal support 610 can couple with the lateral support 415. For example, the longitudinal support 610 can be fixedly coupled with the lateral support 415 (e.g., by welding, soldering, adhesive, etc.) or removably coupled with the lateral support 415 (e.g., by bolts, screws, brackets, etc.). For example, the longitudinal support 610 can extend between a top side of a first lateral support 415 and a bottom side of a second lateral support 415.

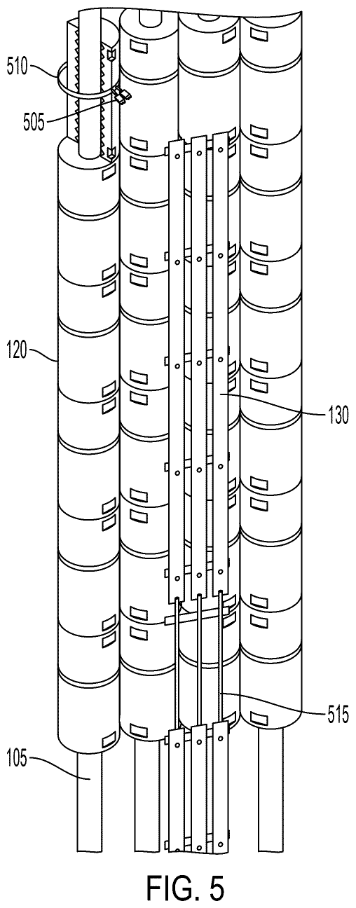

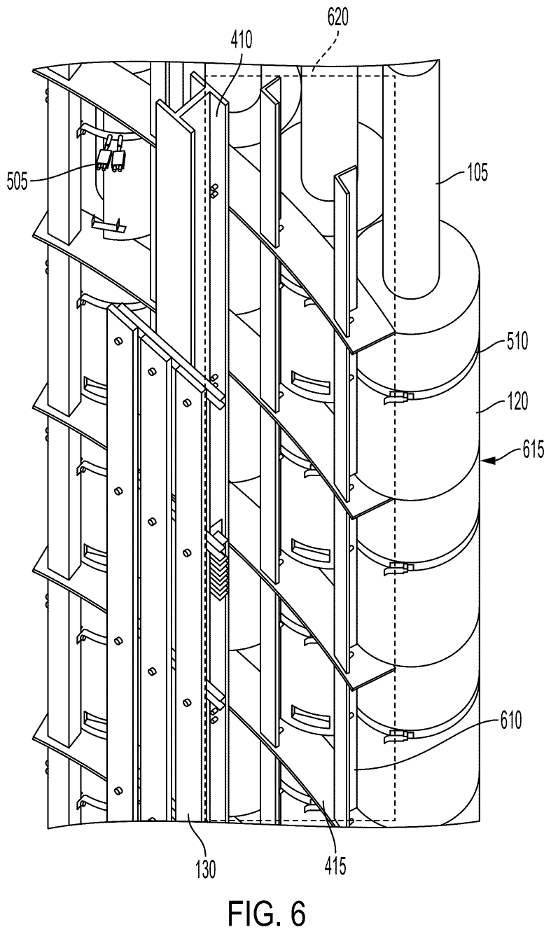

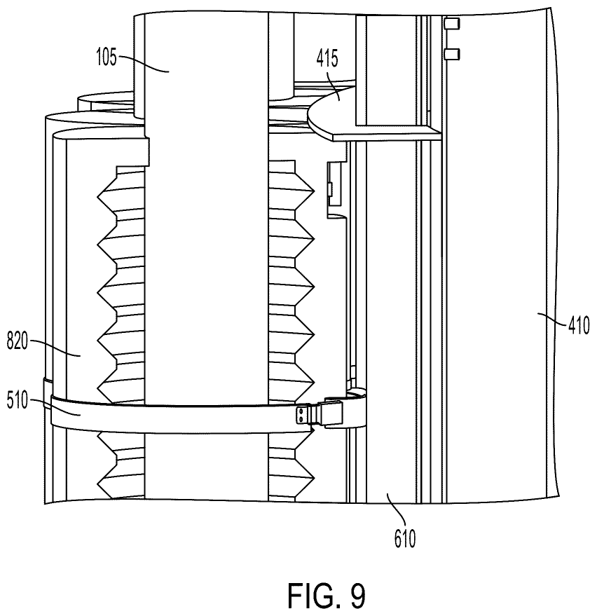

As shown in FIG. 9, among others, at least one strap 510 can extend around a circumference of the heating element 120. The straps 510 can be made of any material configured to withstand surface temperatures of the heating element 120 (e.g., stainless steel, carbon steel, titanium alloys, nickel alloys, etc.). For example, the straps 510 can be made of or include materials configured to withstand temperatures of less than 250 °F, a range of temperatures between 250 °F-350 °F, or temperatures greater than 350 °F. The length of the straps 510 may vary based on an exterior circumference or outer diameter 830 of the heating element 120. For example, the strap 510 can extend around the circumference of the heating element 120 to couple the first semi-circular segment 815 with the second semi-circular segment 820. The strap 510 can engage with longitudinal support 610 to couple the heating element 120 with the longitudinal support 610. As shown in FIGS. 5 and 6, among others, the strap 510 can include at least one power plug 505. The power plug 505 can couple with the heating element 120. For example, the power plug 505 can couple with the heating element 120 by electrical cables or wires. The power plug 505 can couple with the busbar 130, such that the power plug 505 receives electrical current from the busbar 130. For example, the power plug 505 can be plugged into a power distribution device connected with the busbar 130, such as a power distribution panel, power supply unit, or junction box, to deliver electric current to the heating element 120.

The connector element 620 can couple with the busbar 130. For example, the beam 410 (or other connector element 620) can couple with the busbar 130. For example, the beam 410 can be fixedly coupled with the busbar 130 (e.g., by welding, soldering, adhesive, etc.). The beam 410 can couple with the busbar 130 by one or more intervening elements, such as bolts, screws, or brackets. The beam 410 can couple with the busbar 130 by non-conductive materials, such as epoxy.

The connector element 620 can couple with the heating element 120. For example, the lateral support 415 (or other connector element 620) can contact the bottom end 810 of the heating element 120 to support the heating element 120. As shown in FIG. 6, among others, the lateral support 415 can extend between an end of a first heating element 120 and an end of a second heating element 120. For example, the lateral support 415 can extend into a space 615 between a top end 805 of the first heating element 120 and the bottom end 810 of the second heating element 120. The lateral support 415 can be fixedly coupled with the heating element 120 (e.g., by welding, soldering, adhesive, etc.) or removably coupled with the heating element 120 (e.g., by bolts, screws, brackets, etc.). The lateral support 415 can be loosely coupled with the heating element 120. For example, the heating element 120 can rest on the lateral support 415 without additional coupling means.

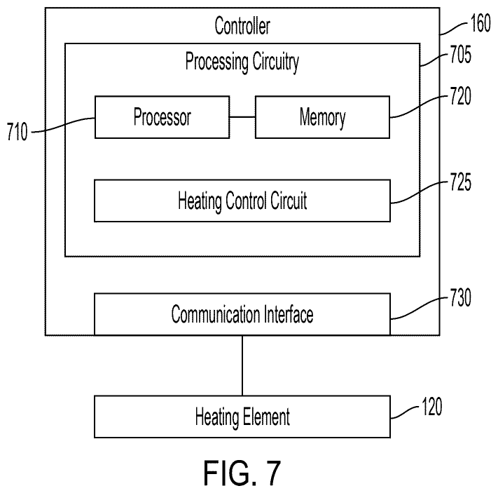

FIG. 7, among others, depicts an example controller 160. The reforming apparatus 100 can include a controller 160. The controller 160 can be communicatively coupled with one or more components of the reforming apparatus 100, such that the controller can transmit control signals to the one or more components of the reforming apparatus 100. The controller 160 can be structured to control, at least partly, the operation of the reforming apparatus 100 and associated components. For example, the controller 160 can be structured to control the operation of the heating element 120. Communication between and among the components can be via any number of wired or wireless connections. For example, a wired connection can include a serial cable, a fiber optic cable, a CAT5 cable, or any other form of wired connection. A wireless connection can include the Internet, Wi-Fi, cellular, radio, etc. A controller area network (CAN) bus provides the exchange of signals, information, or data. The CAN bus can include any number of wired and wireless connections. The controller 160 can be structured as one or more electronic control units (ECUs), such as one or more microcontrollers. The controller 160 can be separate from or included with the reforming apparatus 100, or more specifically, the heating element 120.

As shown in FIG. 7, among others, the controller 160 can include at least one processing circuitry 705 having at least one processor 710 and at least one memory device 720, a heating control circuit 725, and a communication interface 730.

The processing circuitry 705 can be structured or configured to execute or implement the instructions, commands, or control processes described herein with respect to the heating control circuit 725. The processor 710 can be one or more single-or multi-chip processors, digital signal processors (DSPs), application-specific integrated circuits (ASICs), field-programmable gate arrays (FPGAs), or suitable processors (e.g., other programmable logic devices, discrete hardware components, etc., to perform the functions described herein). The processor 710 can be a microprocessor, a group of processors, etc. A processor also can be implemented as a combination of computing devices, such as a combination of a DSP and a microprocessor, a plurality of microprocessors, one or more microprocessors in conjunction with a DSP core, or any other such configuration. The processor 710 can be shared by multiple circuits (e.g., the heating control circuit 725). The processor 710 can be structured to perform or otherwise execute certain operations independent of one or more co-processors.

The memory device 720 can include one or more devices (e.g., RAM, ROM, Flash memory, hard disk storage) for storing data or computer code for completing or facilitating the various processes, layers and modules described in the present disclosure. For example, the memory device 720 can include dynamic random-access memory (DRAM). The memory device 720 can be communicably connected to the processor 710 to provide computer code or instructions to the processor 710 for executing at least some of the processes described herein. The memory device 720 can be or include tangible, non-transient volatile memory or non-volatile memory. For example, the memory device 720 can include database components, object code components, script components, or any other type of information structure for supporting the various activities and information structures described herein.

The communication interface 730 can include any combination of wired or wireless interfaces (e.g., jacks, antennas, transmitters, receivers, transceivers, wire terminals) for conducting data communications with various systems, devices, or networks structured to enable in-reforming apparatus 100 communications (e.g., between and among the components of the reforming apparatus 100) and out-of-reforming apparatus 100 communications (e.g., with a remote server). For example, and regarding out-of-reforming apparatus 100 communications, the communication interface 730 can include an Ethernet card and port for sending and receiving data via an Ethernet-based communications network or a Wi-Fi transceiver for communicating via a wireless communications network. The communication interface 730 can be structured to communicate via local area networks or wide area networks (e.g., the Internet) and can use a variety of communications protocols (e.g., IP, LON, Bluetooth, ZigBee, radio, cellular, near field communication).

The heating control circuit 725 can be machine-or computer-readable media storing instructions that are executable by a processor, such as processor 710. The machine-readable media can facilitate performance of certain operations to enable reception and transmission of data. For example, the machine-readable media can provide an instruction (e.g., command, etc.) to, e.g., acquire data. In this regard, the machine-readable media can include programmable logic that defines the frequency of acquisition of the data (or transmission of the data). The computer-readable media instructions can include code, which can be written in any programming language, including, but not limited to, Java or the like, and any conventional procedural programming languages, such as the “C” programming language or similar programming languages. The computer-readable program code can be executed on one processor or multiple remote processors. In the latter scenario, the remote processors can be connected to each other through any type of network (e.g., CAN bus, etc.).

The heating control circuit 725 can be one or more hardware units, such as one or more electronic control units. As such, the heating control circuit 725 can be one or more circuitry components, including, but not limited to, processing circuitry, network interfaces, peripheral devices, input devices, output devices, sensors, etc. The heating control circuit 725 can take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” The heating control circuit 725 can include any type of component for accomplishing or facilitating achievement of the operations described herein. For example, a circuit as described herein can include one or more transistors, logic gates (e.g., NAND, AND, NOR, OR, XOR, NOT, XNOR, etc.), resistors, multiplexers, registers, capacitors, inductors, diodes, wiring, and so on. The heating control circuit 725 can be programmable hardware devices such as field-programmable gate arrays, programmable array logic, programmable logic devices or the like. The heating control circuit 725 can include one or more memory devices for storing instructions that are executable by the processor(s) of the heating control circuit 725. The heating control circuit 725 can be geographically dispersed throughout separate locations in the reforming apparatus 100. As shown in FIG. 7, among others, the heating control circuit 725 can be within a single unit/housing, which is shown as the controller 160.

The controller 160, and more specifically, the heating control circuit 725 can transmit control signals to the heating element 120. For example, the heating control circuit 725 can transmit control signals to the heating element 120 to operate the heating element 120 at a particular temperature. As mentioned above, the reforming apparatus 100 can include multiple heating elements 120. For example, the reforming apparatus 100 can include a first heating element 120 and a second heating element 120. The first heating element 120 and the second heating element 120 can be disposed on the same catalyst tube 105, or on different catalyst tubes 105. For example, the first heating element 120 can couple with a first catalyst tube 105 while the second heating element 120 can couple with a second catalyst tube. The heating control circuit 725 can transmit control signals to the first heating element 120 to operate the first heating element 120 at a first temperature. The heating control circuit 725 can transmit control signals to the second heating element 120 to operate the second heating element 120 at a second temperature. The first temperature can be different from the second temperature. For example, the first temperature can be higher than the second temperature.

As shown in FIG. 1, among others, multiple heating elements 120 can be positioned along the length of the catalyst tube 105. The heating elements 120 can be arranged along the length of the catalyst tube 105 according to heating zones. The heating elements 120 can be arranged into any number of heating zones. For example, the heating elements 120 can be arranged into at least two heating zones, at least three heating zones, or a number of heating zones greater than three. For example, there can be 20-50 heating zones as well as a number of zones both less than 20 or greater than 50. There can be one heating zone for each individual heating element 120. For example, the length of the catalyst tube 105 can be divided into a first heating zone 140, a second heating zone 145, and a third heating zone 150. The first heating zone 140, the second heating zone 145, and the third heating zone 150 can be same size (e.g., such that the total length of the catalyst tube 105 is divided into three equal or substantially equal lengths). The first heating zone 140, the second heating zone 145, and the third heating zone 150 also can be different sizes. For example, the first heating zone 140 can occupy a larger length of the catalyst tube 105 than the second heating zone 145 and the third heating zone 150. The first heating zone 140 can be positioned nearest the second platform 115 relative to the second heating zone 145 and the third heating zone 150. The third heating zone 150 can be positioned nearest the first platform 115 relative to the second heating zone 145 and the first heating zone 140. The second heating zone 145 can be positioned between the first heating zone 140 and the third heating zone 150.

The controller 160 can define a plurality of heating zones by operating the heating elements 120 positioned along the length of the catalyst tube 105 at varying temperatures. The controller 160 can operate the heating elements 120 in a range of temperatures between 700 °C and 1100 °C, for example, 750-1050 °C. The controller 160 can operate each heating element 120 along a length of the catalyst tube 105 at the same temperature to define a single heating zone. The controller 160 can operate each heating element 120 positioned along the length of the catalyst tube 105 at a different temperature, such that the number of heating elements 120 defines the number of heating zones. For example, the controller 160 can define the first heating zone 140 by operating one or more heating elements 120 at a first temperature or temperature range. The controller 160 can define the second heating zone 145 by operating one or more heating elements 120 at a different second temperature or temperature range. The controller 160 can define the third heating zone 150 by operating one or more heating elements 120 at a different third temperature or temperature range.

A first heating element 120 can be positioned a first distance from the second platform 115 along the length of the catalyst tube 105. A second heating element 120 can be positioned a second distance from the second platform 115 along the length of the catalyst tube 105. The first distance can be less than the second distance. For example, the first heating element 120 can be positioned in the first heating zone 140 and the second heating element 120 can be positioned in the second heating zone 145 or the third heating zone 150. The controller 160 can operate the first heating element 120 at a first temperature. The controller 160 can operate the second heating element 120 at a second temperature. The first temperature can be higher than the second temperature. For example, the controller 160, or more specifically, the heating control circuit 725, can operate multiple heating elements 120 within the first heating zone 140 at the first temperature. The heating control circuit 725 can operate multiple heating elements 120 within the second heating zone 145 or the third heating zone 150 at the second temperature. In this way, a portion of the catalyst tubes 105 within the first heating zone 140 can be heated at the first, higher, temperature. The remaining portion or portions of the catalyst tube 105 within the second heating zone 145 or the third heating zone 150 can be heated at the second, lower, temperature. For example, the controller 160 can operate the heating elements 120 within the first heating zone 140 to heat the catalyst tube 105 to 900-1100 °C. The controller 160 can operate the heating elements 120 within the first heating zone 140 at varying temperatures within the 900-1100 °C range. For example, the controller 160 can operate a first heating element 120 within the first heating zone 140 at 1000 °C and a second heating element 120 within the first heating zone 140 at 900 °C. The controller 160 can operate the heating elements 120 within the second heating zone 145 or the third heating zone 150 to heat the catalyst tube 105 to 700-900 °C. The controller 160 can operate the heating elements 120 within the second heating zone 145 at varying temperatures within the 700-900 °C range. For example, the controller 160 can operate a first heating element 120 within the second heating zone 140 at 850 °C and a second heating element 120 within the second heating zone 140 at 800 °C. The controller 160 can operate the heating elements 120 within the third heating zone 150 at varying temperatures within the 700-900 °C range. For example, the controller 160 can operate a first heating element 120 within the third heating zone 150 at 750 °C and a second heating element 120 within the third heating zone 140 at 700 °C.

The first heating element 120 can be positioned a first distance from the second platform 115 along the length of the catalyst tube 105. The second heating element 120 can be positioned a second distance from the second platform 115 along the length of the catalyst tube 105. The first distance can be less than the second distance. A third heating element 120 can be positioned between the first heating element 120 and the second heating element 120 along the length of the catalyst tube 105. For example, the first heating element 120 can be positioned in the first heating zone 140, the second heating element 120 can be positioned in the third heating zone 150, and the third heating element 120 can be positioned in the second heating zone 145. The controller 160 can operate the first heating element 120 at a first temperature. The controller 160 can operate both the second heating element 120 and the third heating element at a second temperature. The first temperature can be higher than the second temperature.

For example, the controller 160, or more specifically, the heating control circuit 725, can operate the heating elements 120 within the first heating zone 140 at the first temperature. The heating control circuit 725 can operate heating elements 120 within the second heating zone 145 and the third heating zone 150 at the second temperature. In this way, a portion of the catalyst tubes 105 within the first heating zone 140 can be heated at the first, higher, temperature. The remaining portion or portions of the catalyst tube 105 within the second heating zone 145 and the third heating zone 150 can be heated at the second, lower, temperature. For example, the controller 160 can operate the heating elements 120 within the first heating zone 140 to heat the catalyst tube 105 to 900-1100 °C. The controller 160 can operate the heating elements 120 within the second heating zone 145 and the third heating zone 150 to heat the catalyst tube 105 to 700-900 °C

The heating control circuit 725 can operate heating elements 120 within the third heating zone 150 at a third temperature, different from the first temperature and the second temperature. For example, the third temperature can be a temperature lower than the second temperature or higher than the second temperature. Alternatively, the third temperature can be the same as the first temperature. For example, the first heating zone 140 of the catalyst tube 105 nearest the second platform 115 can be heated at a first, higher, temperature. The second heating zone 145 of the catalyst tube 105 can be heated at a second temperature lower than the first temperature. The third heating zone 150 of the catalyst tube 105 can be heated at a third temperature, lower than the second temperature.

At least one busbar 130 can couple with the heating elements 120. For example, a first busbar 130 can couple with the first heating element 120. A second busbar 130 can couple with the second heating element 120. The first busbar 130 can transmit power from a first power source to the first heating element 120 to heat the first heating element 120. The first power source can provide a first power to the first heating element 120. For example, the first power can be a wattage transferred from the first power source to the first heating element 120 via the first busbar 130. The second busbar 130 can transmit power from a second power source to the second heating element 120. The second power source can provide a second power to the second heating element 120 to heat the second heating element 120. For example, the second power can be a wattage transferred from the second power source to the second heating element 120 via the second busbar 130. The first power provided to the first heating element 120 can be different from the second power provided to the second heating element 120. For example, a wattage of the first power can be greater than a wattage of the second power. For example, a wattage of the first power provided to the first heating element 120 can be 75 kW and the wattage of the second power provided to the second heating element 120 can be 60 kW. The first power can correspond to the first temperature associated with the first heating zone 140 described above. For example, the higher first power relative to the second power, can correspond to the higher first temperature. The second power can correspond to the second temperature associated with the second heating zone 145 or the third heating zone 150 described above. For example, the lower second power relative to the first power, can correspond to the lower second temperature.

As shown in FIGS. 4-6, among others, the catalyst tubes 105 can be organized into segments 405 within the reforming apparatus 100. For example, the segments 405 can include multiple catalyst tubes 105. As shown in FIGS. 4-6, among others, the segments 405 can include a first catalyst tube 105, a second catalyst tube 105, a third catalyst tube 105, and a fourth catalyst tube 105. At least one heating element 120 can be thermally coupled with each of the first catalyst tube 105, the second catalyst tube 105, the third catalyst tube 105, and the fourth catalyst tube 105. For example, a first heating element 120 can be thermally coupled with the first catalyst tube 105. A second heating element 120 can be thermally coupled with the second catalyst tube 105. A third heating element 120 can be thermally coupled with the third catalyst tube 105. A fourth heating element 120 can be thermally coupled with the fourth catalyst tube 105.

Thermally coupling the heating element 120 with the catalyst tubes 105 can include positioning the heating element 120 in a proximity of the catalyst tubes 105 such that the heating element 120 transfers heat to the catalyst tubes 105. For example, thermally coupling the heating element 120 with the catalyst tubes 105 can include the heating element 120 being in contact with an exterior surface of the catalyst tubes 105. Thermally coupling the heating element 120 with the catalyst tubes 105 can include positioning the heating element 120 such that a gap exists between inner surface of the heating element 120 and the exterior surface of the catalyst tubes 105.

The segments 405 can include at least one busbar 130. For example, the segments 405 can include a single busbar 130 coupled with each of the first heating element 120, the second heating element 120, the third heating element 120, and the fourth heating element 120. The busbar 130 can transmit power from the power source to each of the first heating element 120, the second heating element 120, the third heating element 120, and the fourth heating element 120. For example, the busbar 130 can electrically couple the first heating element 120, the second heating element 120, the third heating element 120, and the fourth heating element 120 with a power source, such as a power grid or electrical battery (e.g., an electrical power source). The busbar 130 transmits electrical current from the electrical power source to each of the first heating element 120, the second heating element 120, the third heating element 120, and the fourth heating element 120.

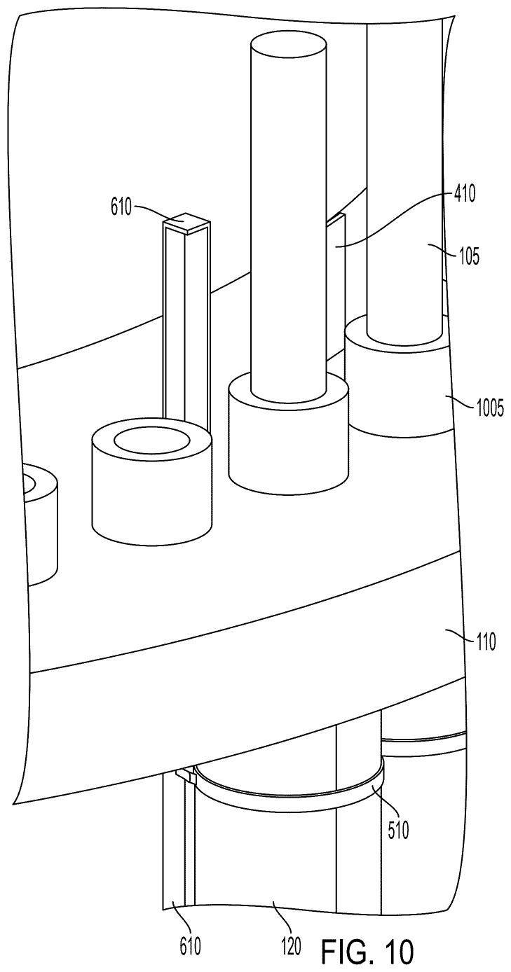

FIG. 10, among others, depicts an example apparatus 100. The reforming apparatus 100 can include insulation 1005. The insulation 1005 can be or include ceramic fiber blanket insulation material. The insulation 1005 can have a density of 6-8 pounds per cubic foot, or a density greater than 8 pounds per cubic foot. The insulation 1005 can have a thickness of 6-8 inches, or a thickness greater than 8 inches. The thickness of the insulation 1005 can vary based on thermal conductivity of the catalyst tube 105. The insulation 1005 can couple with the first end of the catalyst tube 105 that extends through and beyond the first opening 210 in the first platform 110. Insulation 1005 can couple with the second end of the catalyst tube 105 that extends through and beyond the first opening 210 in the second platform 115. For example, the insulation 1005 can be disposed around a portion of a circumference of the catalyst tube 105. For example, the insulation 1005 can be disposed around 50%-100% of the circumference of the catalyst tube 105. The catalyst tube 105 can extend through and beyond the insulation 1005. Alternatively, the insulation 1005 can extend to an edge of the end of the catalyst tube 105. The insulation 1005 coupled with the first end of the catalyst tube 105 can define a first thickness. The insulation 1005 coupled with the second end of the catalyst tube can define a second thickness. The first thickness can be different from the second thickness. For example, the first thickness can be greater than the second thickness.

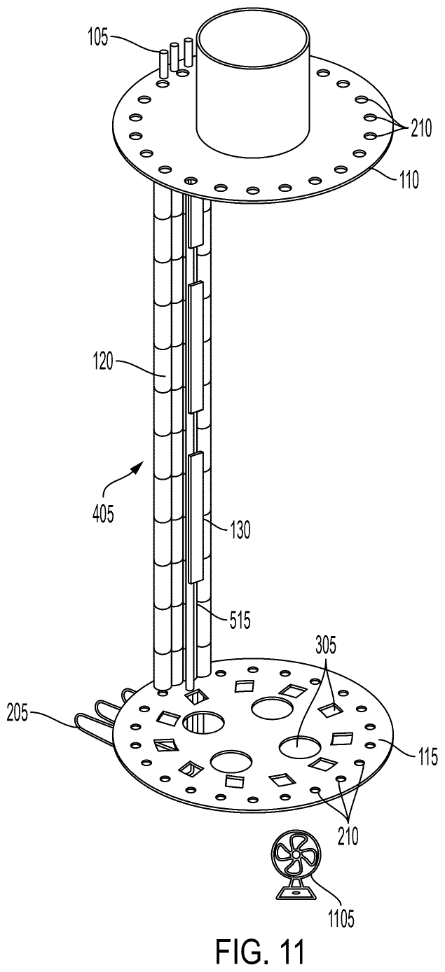

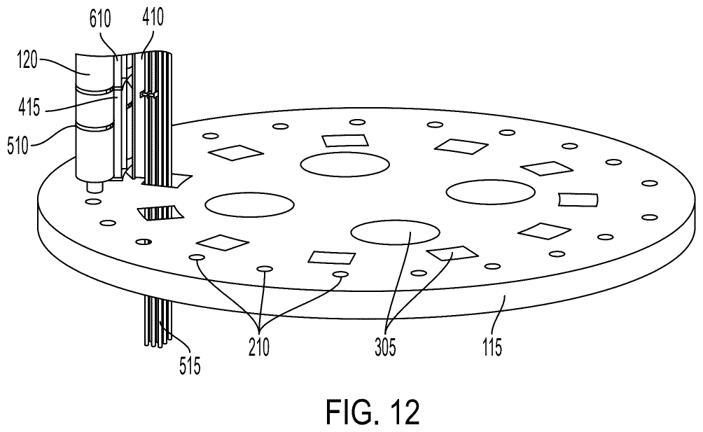

FIGS. 11 and 12, among others, depicts an example apparatus 100. The second platform 115 can include at least one second opening 305. The second opening 305 can be a different size than the first opening 210. The second opening 305 can receive components of the reforming apparatus 100. For example, the second opening 305 can receive the busbar 130. An end of the busbar 130 can extend through and beyond the opening 305. The second opening 305 can receive one or more components of the connector element 620. For example, the second opening 305 can receive the beam 410. The beam 410 can extend through and beyond the opening 305. The busbar 130 and the beam 410 can extend through the same second opening 305, or the busbar 130 and the beam 410 can each extend through separate second openings 305. The second opening 305 can receive the longitudinal support 610. The longitudinal support 610 can extend through and beyond the second opening 305.

The second opening 305 can be structured as air ventilation openings. For example, a fan 1105 can direct air through the second opening 305 to cool one or more components of the reforming apparatus 100. The fan 1105 can include a blower motor that drives a blower wheel. The blower wheel can include blades that, when rotating, increase air pressure and direct airflow into reforming apparatus 100. For example, and as shown in FIG. 11, among others, a fan 1105 can couple with the reforming apparatus 100. The fan 1105 can direct air through the second opening 305 in the second platform 115 to cool one or more components of the reforming apparatus 100. For example, the fan 1105 can direct air through the second opening 305 in the second platform 115 to cool the exterior surfaces of the heating element 120, the busbar 130, the connector element 620 (e.g., the lateral support 415, the longitudinal support 610, the beam 410).

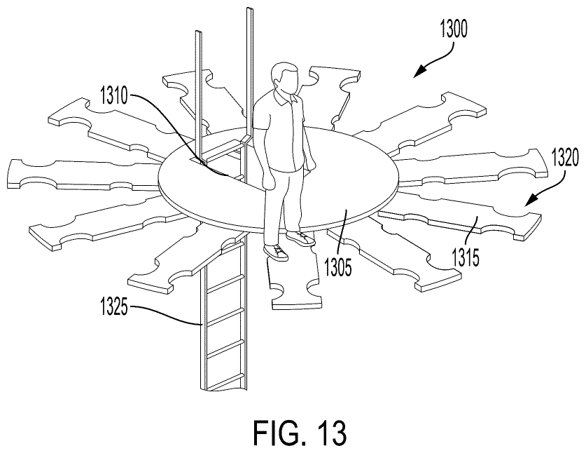

FIG. 13, among others, depicts an example maintenance platform 1300. The reforming apparatus 100 can include at least one maintenance platform 1300. For example, the maintenance platform 1300 is a structure designed to provide access to various components of the reforming apparatus 100. The maintenance platform 1300 can be positioned between the first platform 110 and the second platform 115. For example, the maintenance platform 1300 can be positioned at a midway point between the first platform 110 and the second platform 115. The maintenance platform 1300 can be fixed or moveable. For example, the maintenance platform 1300 can be moved along the length of the reforming apparatus 100 based on an area of the catalyst tube 105, or a heating element 120 positioned along the length of the catalyst tube 105, needing maintenance. The maintenance platform 1300 can include at least one central portion 1305. The central portion 1305 can include an opening 1310 that allows users to access a top surface of the maintenance platform 1300. For example, a ladder 1325 can extend through and beyond the opening 1310. A user can climb the ladder 1325 and pass through the opening 1310 to access the top surface of the maintenance platform 1300.

The maintenance platform 1300 can include at least one extension portion 1315. The extension portion 1315 can extend away from the central portion 1305. For example, the extension portion 1315 can extend away from an edge of the central portion 1305 and towards the catalyst tube 105 and the heating element 120. The extension portion 1315 can include at least one recessed portion 1320. The recessed portion 1320 can receive, fit around, or otherwise provide clearance for components of the reforming apparatus 100. For example, the recessed portion 1320 can curve to receive the heating element 120. The extension portion 1315 can extend between catalyst tubes 105 and heating elements 120 to provide access to the catalyst tubes 105 and heating elements 120. For example, a user can walk on the extension portion 1315 to access the heating element 120 (e.g., for maintenance, replacement, etc.).

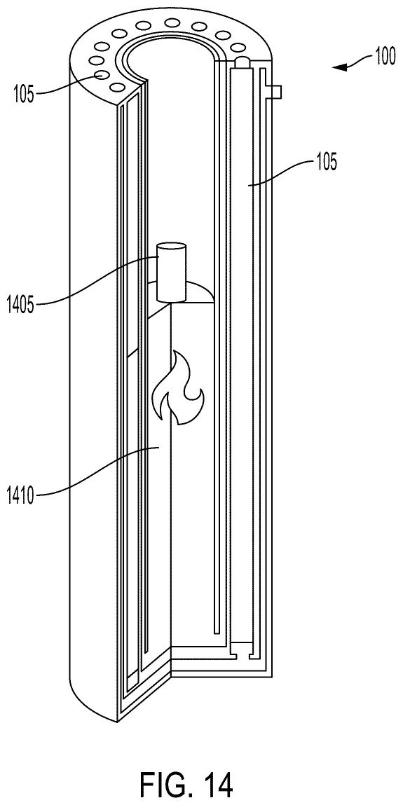

FIG. 14, among others, depicts an example apparatus 100. The reforming apparatus 100 can include a burner 1405. For example, the burner 1405 can be a combustion device that generates heat. For example, the burner 1405 can receive fuel from a fuel source (e.g., a fossil fuel, a carbon-based fuel, etc.) and ignite the fuel to generate heat. The burner 1405 can direct the heat, or more specifically, a flame to a combustion chamber 1410. The combustion chamber 1410 can be an enclosure that contains the combustive process of the burner 1405 igniting fuel. The combustion chamber 1410 can include additional burners. The combustion chamber 1410 can extend along a portion of the length of the catalyst tube 105. For example, the combustion chamber 1410 can provide radiant heat transfer to the catalyst tube 105 generated during the fuel combustion process.

The reforming apparatus 100 can be retrofitted with the heating elements 120. For example, by removing the burner 1405 from the reforming apparatus 100. Additionally or alternatively, by removing the combustion chamber 1410 from the reforming apparatus 100. The reforming apparatus 100 can be retrofitted with the heating elements 120 without removing the burner 1405 or the combustion chamber 1410. For example, the fuel supply to the burner 1405 or the combustion chamber 1410 can be cut off. For example, a user can turn off the fuel supply to the burner 1405 or the combustion chamber 1410 temporarily or permanently. The reforming apparatus 100 can be retrofitted with the heating elements 120 by installing the heating element 120 to be disposed around a portion of the circumference of the catalyst tube 105. The connector element 620 can be installed to support the heating element 120, among other components of the reforming apparatus 100. For example, the connector element 620 can be installed by installing the lateral support 415 and the beam 410. The lateral support 415 can be installed to contact the bottom end 810 of the heating element 120, for example, to at least partially support the weight of the heating element 120. The beam 410 can couple with the lateral support 415. The busbar 130 can couple with the connector element 620. For example, by coupling the busbar 130 with the beam 410. The busbar 130 can couple with a power source. For example, the busbar 130 can be connected with an electric grid via electrical cables 515. The busbar 130 can be connected with the heating element 120 to transmit electrical current from the electric grid to the heating element 120.

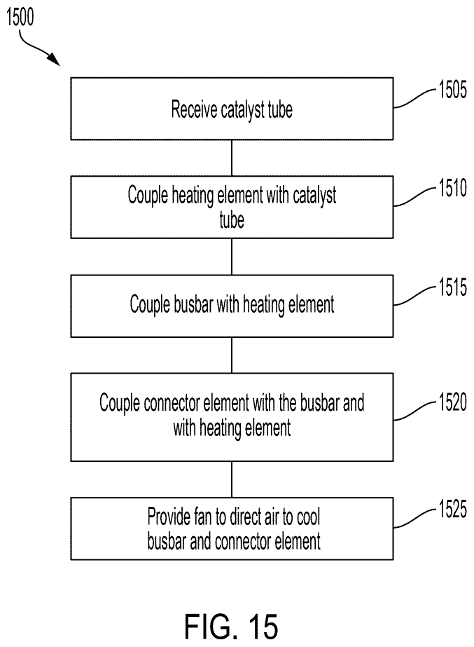

FIG. 15, among others, depicts an example of method 1500 of producing the reforming apparatus 100. The method 1500 can include at least one act of receiving a catalyst tube 105 (e.g., act 1505). For example, the first platform 110 can receive the first end of the catalyst tube 105. The first platform 110 can receive the first end of the catalyst tube 105 via the first opening 210. A second platform 115 can receive a second end of the catalyst tube 105. The second platform 115 can receive the second end of the catalyst tube 105 via a first opening 210. The first platform 110 and the second platform 115 can each receive an end catalyst tube 105, such that the catalyst tube 105 extends between the first platform 110 and the second platform 115. The catalyst tube 105 can couple with the first platform 110 or the second platform 115. For example, the catalyst tube 105 can be welded, soldered, or adhered with the first platform 110 or the second platform 115. The catalyst tube 105 can couple with the first platform 110 or the second platform 115 by fasteners, such as bolts, screws, brackets, or the like. The catalyst tube 105 can be received by the first opening 210 of the first platform 110 or the second platform 115 via one or more intervening members, such as collars, clamshell clamps, or the like. The intervening members can be positioned within the first opening 210 or can be positioned at an entrance of the first opening 210 such that the intervening members extend away from the first opening 210.

The method 1500 can include at least one act of coupling a heating element 120 with the catalyst tube 105 (e.g., act 1510). The heating element 120 can include a first heating element 120 and a second heating element 120. Act 1510 can include coupling the first heating element 120 and the second heating element 120 with the catalyst tube 105. For example, the first heating element 120 and the second heating element 120 can be disposed around a portion of the circumference of the catalyst tube 105. The heating element 120 can each be secured in place by a strap 510 to couple the heating element 120 with the catalyst tube 105. The heating element 120 can couple with the catalyst tube 105 by joining a first semi-circular segment 815 and a second semi-circular segment 820. The segments are positioned opposite each other, with the catalyst tube 105 running through a central opening formed by the two segments. The heating element 120 can be in contact with the catalyst tube 105 while coupled with the catalyst tube 105. The heating element 120 can couple with the catalyst tube 105 via one or more intervening members (e.g., sleeves, collars, etc.). The heating element 120 can be spaced apart from the catalyst tube 105 while coupled with the catalyst tube 105 such that the heating elements 120 do not contact the exterior surface of the catalyst tube 105.

The method 1500 can include at least one act of coupling a busbar 130 with the heating element 120 (e.g., act 1515). For example, the act 1515 can include coupling the busbar 130 with the first heating element 120 and the second heating element 120. For example, the busbar 130 can be electrically coupled with the first heating element 120 and the second heating element 120. The busbar 130 can be electrically coupled with the first heating element 120 and the second heating element 120 via one or more electrical cables 515.

The method 1500 can include at least one act of coupling a connector element 620 with the busbar 130 and the heating element 120 (e.g., act 1520). For example, act 1520 can include coupling the connector element 620 with the first heating element 120 and the second heating element 120. For example, the connector element 620 can include at least one beam 410 and at least one lateral support 415. The method 1500 can include coupling the beam 410 with the busbar 130. For example, the beam 410 can be removably coupled with the busbar 130 using bolts, screws, brackets, or the like. The beam 410 can be fixedly coupled with the busbar 130 by welding, soldering, or adhesive. The lateral support 415 can be fixedly coupled with the heating element 120 by welding, soldering, adhesive, or the like. The lateral support 415 can be removably coupled with the heating element 120 by bolts, screws, brackets or the like. The lateral support 415 can be loosely coupled with the first heating element 120 and with the second heating element 120. For example, the first heating element 120 and the second heating element 120 can rest on the lateral support 415 without additional coupling means.

The method 1500 can include providing a fan 1105 to direct air through the second opening 305 in the second platform 115 (e.g., act 1525). For example, the fan 1105 can be communicatively coupled with the controller 160. The controller 160 can transmit a control signal to the fan 1105 to operate the fan 1105. In response to receiving the control signals, the fan 1105 can activate, turn on from an off state, or the like. In response to receiving the control signals, the fan 1105 can adjust its operation to output more or less air. For example, by changing a speed of a blower motor and a blower wheel within the fan 1105.

The method 1500 can include additional acts. The method 1500 can include at least one act of communicatively coupling a controller 160 with the heating element 120. For example, act 1525 can include coupling the controller 160 with the first heating element 120 and the second heating element 120. Communicatively coupling the controller 160 with the heating element 120 can be via any number of wired or wireless connections. For example, a wired connection can include a serial cable, a fiber optic cable, a CAT5 cable, or any other form of wired connection. In comparison, a wireless connection can include the Internet, Wi-Fi, cellular, radio, etc.

The method 1500 can include at least one act of operating the first heating element 120 at a first temperature. For example, the controller 160 can transmit control signals to the first heating element 120 to operate the first heating element 120 at the first temperature. In response to receiving the control signals, the heating element 120 can activate, turn on from an off state, or the like. In response to receiving the control signals, the heating element 120 can adjust its operation to operate at the first temperature. For example, by changing its heat output relative to a previous heat output until the heat output matches the first temperature.

The method 1500 can include at least one act of operating the second heating element 120 at a second temperature. For example, the controller 160 can transmit control signals to the second heating element 120 to operate the second heating element 120 at the second temperature. In response to receiving the control signals, the heating element 120 can activate, turn on from an off state, or the like. In response to receiving the control signals, the heating element 120 can adjust its operation to operate at the second temperature. For example, by changing its heat output relative to a previous heat output until the heat output matches the second temperature.

The method 1500 can include positioning the beam 410 between the first platform 110 and the second platform 115. For example, the beam 410 be coupled with the first platform 110 and the second platform 115. The beam 410 can extend through and beyond the second opening 305 in the second platform 115. The beam 410 can extend through and beyond a second opening in the first platform 110. The beam 410 can be positioned between the first platform 110 and the second platform 115 without contacting the first platform 110 and the second platform 115. For example, the beam 410 can span a distance that is less than the distance between the first platform 110 and the second platform 115. The beam 410 can be positioned aside the catalyst tube 105. For example, the beam 410 can be closer to the central longitudinal axis 155 than the catalyst tube 105.

The method 1500 can include coupling the lateral support 415 with the beam 410. A portion of the lateral support 415 can extend between an end of the first heating element 120 and an end of the second heating element 120. For example, the lateral support 415 can extend between the bottom end 810 of the first heating element 120 and the top end 805 of the second heating element 120.

The method 1500 can include positioning the first heating element 120 a first distance from the second platform 115 along the length of the catalyst tube 105. The method 1500 can include positioning a second heating element 120 a second distance from the second platform 115 along the length of the catalyst tube 105. The first distance can be less than the second distance. The method 1500 can include operating the first heating element 120 at the first temperature and operating the second heating element at the second temperature. The first temperature can be higher than the second temperature.

The method 1500 can include positioning a third heating element 120 along the length of the catalyst tube 105 between the first heating element 120 and the second heating element 120. For example, the third heating element 120 can be positioned a third distance from the second platform 115. The third distance can be greater than the first distance and less than the second distance. The method 1500 can include operating the first heating element 120 at the first temperature. The method 1500 can include operating the second heating element 120 and the third heating element 120 at the second temperature. The first temperature can be higher than the second temperature.

The method 1500 can include installing a maintenance platform 1300 to provide access to the heating element 120 and the catalyst tube 105. The maintenance platform 1300 can be positioned between the first platform 110 and the second platform 115. For example, the maintenance platform 1300 can be positioned at a midway point between the first platform 110 and the second platform 115. The maintenance platform 1300 can be fixed or moveable. For example, the maintenance platform 1300 can be moved along the length of the reforming apparatus 100 based on an area of the catalyst tube 105, or a heating element 120 positioned along the length of the catalyst tube 105, needing maintenance.

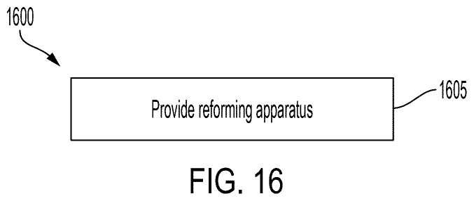

FIG. 16, among others, depicts an example of method 1600 of providing the reforming apparatus 100. The method 1600 can include at least one act of providing a reforming apparatus 100 (e.g., act 1605). For example, providing a reforming apparatus 100 can include providing (e.g., assembling or manufacturing) a reforming apparatus 100 that includes a catalyst tube 105, a heating element 120, a busbar 130, a connector element 620, and a controller 160. The catalyst tube 105 can extend between a first platform 110 and a second platform 115, as described above. The heating element 120 can be disposed around a portion of the circumference of the catalyst tube 105, as described above. The heating element 120 can include a first heating element 120 and a second heating element 120. The busbar 130 can couple with the heating element 120, as described above. More specifically, the busbar can couple with the first heating element 120 and the second heating element 120. The connector element 620 can couple with the busbar 130, as described above. The connector element 620 can couple with the heating element 120, as described above. More specifically, the connector element 620 (e.g., the lateral support 415, the beam 410, the longitudinal support 610) can couple with the first heating element 120 and the second heating element 120. The controller 160 can be communicatively coupled with the heating element 120, as described above. More specifically, the controller 160 can be communicatively coupled with the first heating element 120 and the second heating element. As described above, the controller 160 can operate the first heating element 120 at a first temperature and the second heating element 120 at a second temperature. The second temperature can be different from the first temperature.

While acts or operations can be depicted in the drawings or described in a particular order, such operations are not required to be performed in the particular order shown or described, or in sequential order, and all depicted or described operations are not required to be performed. Actions described herein can be performed in different orders.

Having now described some illustrative implementations, it is apparent that the foregoing is illustrative and not limiting, having been presented by way of example. Features that are described herein in the context of separate implementations can also be implemented in combination in a single embodiment or implementation. Features that are described in the context of a single implementation can also be implemented in multiple implementations separately or in various sub-combinations.

The phraseology and terminology used herein are for the purpose of description and should not be regarded as limiting. The use of “including,” “comprising,” “having,” “containing,” “involving,” “characterized by,” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can include implementations including a plurality of these elements, and any references in plural to any implementation or element or act herein can include implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

References to “or” can be construed as inclusive so that any terms described using “or” can indicate any of a single, more than one, and all of the described terms. References to at least one of a conjunctive list of terms can be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts, such as variations in sizes, dimensions, structures, shapes and proportions of the various elements, values of parameters, mounting arrangements, use of materials, colors and orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein can be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

Systems and methods described herein can be embodied in other specific forms without departing from the characteristics thereof. For example, descriptions of positive and negative electrical characteristics can be reversed. For example, elements described as negative elements can instead be configured as positive elements and elements described as positive elements can instead be configured as negative elements. Further relative parallel, perpendicular, vertical or other positioning or orientation descriptions include variations within +/−10% or +/−10 degrees of pure vertical, parallel or perpendicular positioning. References to “approximately,” “about,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

At least one aspect is directed to a reforming apparatus. The reforming apparatus can include a catalyst tube. The catalyst tube can extend between a first platform and a second platform. The reforming apparatus can also include a heating element. The heating element can be disposed around a portion of a circumference of the catalyst tube. The reforming apparatus can include a busbar. The busbar can couple with the heating element. The busbar can transmit power from a power source to the heating element. The reforming apparatus can include a connector element. The connector element can couple with the busbar and with the heating element.

What is claimed is:

1. A reforming apparatus, comprising:
a catalyst tube to extend between a first platform and a second platform;
a first heating element to dispose around a circumference of the catalyst tube at a first portion of the catalyst tube;
a second heating element to dispose around a circumference of the catalyst tube at a second portion of the catalyst tube;
a busbar coupled with the first heating element and with the second heating element to transmit power from a power source to the first heating element and to the second heating element;
a connector element to couple with the busbar, the first heating element, and the second heating element; and
a controller communicatively coupled with the first heating element and the second heating element, the controller to:
operate the first heating element at a first temperature; and
operate the second heating element at a second temperature.

2. The reforming apparatus of claim 1, comprising:
a beam extending between the first platform and the second platform; and
a lateral support to couple with the beam, a portion of the lateral support extending between an end of the first heating element and an end of the second heating element.

3. The reforming apparatus of claim 1, comprising:
insulation to at least partially dispose around a circumference of the catalyst tube at a third portion of the catalyst tube.

4. The reforming apparatus of claim 1, comprising:
the first heating element positioned a first distance from the second platform;
the second heating element positioned a second distance from the second platform, wherein the first distance is less than the second distance; and
the controller to:
operate the first heating element at the first temperature; and
operate the second heating element at the second temperature, the first temperature different from the second temperature.

5. The reforming apparatus of claim 1, comprising:
the first heating element positioned a first distance from the second platform;
the second heating element positioned a second distance from the second platform, wherein the first distance is less than the second distance;
a third heating element positioned at a third portion of the catalyst tube and between the first heating element and the second heating element; and
the controller communicatively coupled with the first heating element, the second heating element, and the third heating element, the controller to:
operate the first heating element at the first temperature, and
operate both the second heating element and the third heating element at the second temperature, the first temperature higher than the second temperature.

6. The reforming apparatus of claim 1, wherein:
the first heating element and the second heating element are each a clamshell heater having a first semi-circular segment and a second semi-circular segment opposite the first semi-circular segment.

7. The reforming apparatus of claim 1, wherein the catalyst tube is a first catalyst tube, comprising:
the first catalyst tube thermally coupled with the first heating element,
a second catalyst tube thermally coupled with the second heating element;
a third catalyst tube thermally coupled with a third heating element;
a fourth catalyst tube thermally coupled with a fourth heating element; and
the busbar coupled with each of the first heating element, the second heating element, the third heating element, and the fourth heating element, the busbar to electrically couple the power source with each of the first heating element, the second heating element, the third heating element, and the fourth heating element.

8. The reforming apparatus of claim 1, wherein the first heating element is a first electric heating element and the second heating element is a second electric heating element, and the busbar transmits electrical current from the power source to the first electric heating element and to the second electric heating element.

9. The reforming apparatus of claim 1, comprising:
the second platform defining an opening to receive at least one of the catalyst tube, the busbar, or the connector element.

10. The reforming apparatus of claim 1, wherein the catalyst tube is a first catalyst tube, comprising:
the first catalyst tube positioned a first distance from a central longitudinal axis of the reforming apparatus; and
a second catalyst tube positioned a second distance from the central longitudinal axis of the reforming apparatus, the second distance greater than the first distance.

11. The reforming apparatus of claim 1, comprising:
a fan to direct air through one or more openings in the second platform to cool the busbar and the connector element.

12. The reforming apparatus of claim 1, comprising:
a maintenance platform to provide access to the first heating element, the second heating element, and the catalyst tube, the maintenance platform positioned between the first platform and the second platform.

13. The reforming apparatus of claim 1, wherein the power source is a first power source and the busbar is a first busbar, comprising:
at least one of the first power source and a second power source configured to provide first power to heat the first heating element via the first busbar and configured to provide second power to heat the second heating element via a second busbar, a wattage of the first power being greater than a wattage of the second power.

14. The reforming apparatus of claim 1, wherein the catalyst tube is a first catalyst tube, comprising:
the first heating element coupled with the first catalyst tube; and
the second heating element coupled with a second catalyst tube.

15. The reforming apparatus of claim 1, comprising:
the catalyst tube to receive a gas including at least one of hydrogen or carbon and to reform the gas.

16. A method of producing a reforming apparatus, comprising:
receiving, by a first platform and a second platform, a catalyst tube;
coupling a heating element with the catalyst tube, the heating element to dispose around a circumference of the catalyst tube and at a portion of the catalyst tube;
coupling a busbar with the heating element to transmit power from a power source to the heating element;
coupling a connector element with the busbar and with the heating element; and
providing a fan to direct air through one or more openings in the second platform to cool the busbar and the connector element.

17. The method of claim 16, wherein the heating element is a first heating element, comprising:
coupling a second heating element with the catalyst tube;
positioning a beam between the first platform and the second platform; and
coupling a lateral support with the beam, a portion of the lateral support extending between an end of the first heating element and an end of the second heating element.

18. The method of claim 16, wherein the heating element is a first heating element, comprising:
positioning the first heating element a first distance from the second platform;
positioning a second heating element a second distance from the second platform, wherein the first distance is less than the second distance;
operating, by a controller, the first heating element at a first temperature; and
operating, by the controller, the second heating element at a second temperature, the first temperature higher than the second temperature.

19. The method of claim 16, wherein the heating element is a first heating element, comprising:
positioning the first heating element a first distance from the second platform;
positioning a second heating element a second distance from the second platform, wherein the first distance is less than the second distance;
positioning a third heating element at a third portion of the catalyst tube and between the first heating element and the second heating element;
operating, by a controller, the first heating element at a first temperature; and
operating, by the controller, both the second heating element and the third heating element at a second temperature, the first temperature higher than the second temperature.

20. A method, comprising:
providing a reforming apparatus, the reforming apparatus comprising:
a catalyst tube to extend between a first platform and a second platform;
a first heating element to dispose around a circumference of the catalyst tube and at a first portion of the catalyst tube;
a second heating element to dispose around a circumference of the catalyst tube and at a second portion of the catalyst tube;
a busbar coupled with the first heating element and with the second heating element to transmit power from a power source to the first heating element and to the second heating element;
a connector element to couple with the busbar, the first heating element, and the second heating element; and
a controller communicatively coupled with the first heating element and the second heating element, the controller to:
operate the first heating element at a first temperature; and
operate the second heating element at a second temperature.
